(19) United States
(12) Patent Application Publication
(10) Pub. No.: US 2026/0160387 A1
(43) Pub. Date: Jun. 11, 2026

(54) Compressor With Housing-Integrated Air Storage Device

(71) Applicant: Robert Bosch GmbH, Stuttgart (DE)

(72) Inventors: Daniel White, Bettendorf, IA (US); Jeremy Rubens, Palatine, IL (US); Walter Bernardi, Highland Park, IL (US)

(21) Appl. No.: 19/181,823

(22) Filed: Apr. 17, 2025

Related U.S. Application Data
(60) Provisional application No. 63/636,365, filed on Apr. 19, 2024.

(51) Int. Cl. F17C 1/06

(52) U.S. Cl. CPC F17C 1/06; F17C 2201/0138; F17C 2203/012; F17C 2203/0624; F17C 2205/0107; F17C 2205/0157; F17C 2221/031; F17C 2227/0157; F17C 2270/0545; F17C 2270/0563

(57) ABSTRACT

A power tool compressor is connected to a compressed air storage device. The compressed air storage device includes a flexible, tubular air storage element and a container element 80 that is configured to receive and store loops of the air storage element. Both the air storage element and the container element are lightweight as compared to some conventional compressed air storage tanks, whereby the compressed air storage device facilitates easy use, storage and transport of the air storage element, resulting in a compact and light weight compressed air storage solution.

### BACKGROUND

Air compressors are commonly used to power a wide range of pneumatic or air-powered tools. Some of the power tools that can be operated using an air compressor include nail guns, impact wrenches, air ratchets, air hammers, drills, sanders and grinders, spray guns, staple guns, et cetera. These are just a few examples of power tools that can be operated using an air compressor. The advantage of pneumatic tools is that they often provide high power and durability while being relatively lightweight and easy to handle. However, air compressors may include a tank to pressurize air and for storage of the pressurized (e.g., compressed) air. Such compressors typically use metal storage tanks that are large, bulky and heavy. This makes them difficult to move and store.

### SUMMARY

In some aspects, a compressed air storage device includes an air storage element and a container element. The air storage element has a flexible, elongated tubular configuration in which the tube is configured to store compressed air. The air storage element may be tightly coiled and/or stowed in the container element, which is a lightweight housing that is shaped and dimensioned to receive the air storage element. The container element facilitates easy use, storage and transport of the air storage element, resulting in a compact and light weight compressed air storage solution.

The compressed air storage device replaces a conventional rigid compressed air storage tank in an air compressor system that also includes an air compressor. The flexible, tubular air storage element has an internal space that extends between and communicates with couplings disposed at opposed ends of the element. The internal space of the air storage element has the volume necessary for storing compressed air used to drive the power tool. To achieve the necessary volume, the air storage element includes a long length of flexible, relatively small diameter tubing to store compressed air. In addition, the air storage element may be tightly coiled and stowed in the lightweight container element for easy use, storage and transport.

The flexible compressed air storage device can be compared to some conventional compressed air storage tanks 601, 602 that have simple curved three dimensional shapes. Some exemplary conventional shapes are shown in FIGS. 8A-C and 9A-C along with a schematic diagram illustrating the forces applied to the tanks by the compressed air stored therein. FIGS. 8A-C illustrate a compressed air storage tank 601 having what is sometimes called a “hot dog” shape, e.g., an elongate, large diameter cylinder having rounded ends. FIGS. 9A-C illustrate a compressed air storage tank 602 having what is sometimes called a “pancake” shape, e.g., a flattened sphere. Since a hand-held pneumatic power tool may require eight liters or more of compressed air to operate, such conventional storage tanks are relatively large in size. The forces on the inner surface of these tanks are equal to the pressure of the compressed air times area of the inner surface. Typical storage tank pressures for air compressors range from 80 to 120 pounds per square inch (psi), while some industrial applications may require higher pressures, reaching up to 200 psi or more. Since the tanks are large to accommodate the required storage volume, the internal forces are also large. For this reason, some conventional compressed air storage tanks are formed of metal and include welded joints. Unfortunately, such tanks are rigid and heavy, ranging from 20 pounds (9 kilograms) to over 100 pounds (45 kilograms), and may be difficult to move from place to place due to their size and weight.

In contrast, the tubular compressed air storage element has a relatively small diameter, for example ranging from 0.25 inches to 1.0 inches in an intermediate region and ranging from 1.0 inches to 10 inches in a large diameter region, whereby the internal pressures of the air storage element are relatively small as compared to some conventional storage tanks. In the air storage element, the required volume is achieved by increasing a length of the element. Since the internal forces are relatively low (due to the smaller area), the air storage element can be made of flexible and relatively lighter weight materials than those used to make a conventional rigid metal storage tank. The container element may also be made of flexible, light weight materials since the stored compressed air is retained within the air storage element.

In some aspects, a compressed air storage device is configured to be connected to an air output of an air compressor. The compressed air storage device includes an air storage element and a container element. The air storage element includes a tubular body having a first end and a tube second end opposite the tube first end. The tubular body has a diameter and a length, where the length is equal to the distance between the tube first end and the tube second end when the tubular body is arranged parallel to a line. The length is at least twenty times the diameter, fifty times the diameter or 100 times the diameter. The tubular body includes a reinforced tube wall. The container element includes a container housing that is shaped and sized to receive the air storage element therein.

In some embodiments, the container element includes a sidewall than encircles the air storage element and a closed end at one end of the sidewall. At least one of the sidewall and the closed end includes perforations.

In some embodiments, at least one of the sidewall and the closed end is formed of a woven material.

In some embodiments, the container element includes a sidewall than encircles the air storage element and a closed end at one end of the sidewall. At least one of the sidewall and the closed end is formed of plastic.

In some embodiments, the container element comprises a sidewall than encircles the air storage element and a closed end at one end of the sidewall, and at least one of the sidewall and the closed end is formed of a pliable material.

In some embodiments, the container element comprises a structural support frame and a woven fabric covering that encloses the support frame.

In some embodiments, the container housing is configured to be selectively opened and closed to permit access to an interior space of the container element.

In some embodiments, the container housing includes a lid that is configured to permit access to an interior space of the container element.

In some aspects, an air compressor system includes an air compressor having an air output, and a compressed air storage device. The compressed air storage device includes an air storage element and a container element. The air storage element includes a tubular body having a tube first end operably connected to the air output and configured to store compressed air, and a tube second end opposite the tube first end. The tubular body has a diameter and a length, where the length is equal to the distance between the tube first end and the tube second end when the tubular body is arranged parallel to a line, the length being at least fifty times the diameter. The tubular body includes a reinforced tube wall. The container element includes a container housing that is shaped and sized to receive the air storage element therein.

In some embodiments, the air compressor system includes an air driven power tool including a tool coupling, wherein the tube second end is operably connected to the tool coupling.

In some embodiments, the container element comprises a sidewall than encircles the air storage element and a closed end at one end of the sidewall, and at least one of the sidewall and the closed end includes perforations.

In some embodiments, at least one of the sidewall and the closed end is formed of a woven material.

In some embodiments, the container element comprises a sidewall than encircles the air storage element and a closed end at one end of the sidewall, and at least one of the sidewall and the closed end is formed of plastic.

In some embodiments, the container element comprises a sidewall than encircles the air storage element and a closed end at one end of the sidewall, and at least one of the sidewall and the closed end is formed of a pliable material.

In some embodiments, the container element comprises a structural support frame and a woven fabric covering that encloses the support frame.

### BRIEF DESCRIPTION OF THE DRAWINGS

FIG. 1 is a schematic diagram of a system for supplying compressed air to a hand-held power tool in which a single line represents an electrical connection and a double line represents a fluid connection.

FIG. 2 is a schematic perspective view of a compressed air storage device illustrating an air storage element disposed inside a container element.

FIG. 3 is a cross-sectional view of the tube of the air storage element as seen along line 3-3 of FIG. 1.

FIG. 4 is a schematic perspective view of a compressed air storage device illustrating an air storage element disposed inside an alternative embodiment container element.

FIG. 5 is a schematic perspective view of a compressed air storage device illustrating an air storage element disposed inside another alternative embodiment container element.

FIG. 6 is a schematic perspective view of a compressed air storage device illustrating an air storage element disposed inside yet another alternative embodiment container element.

FIG. 7 is a schematic side cross-sectional view of the compressed air storage device of FIG. 6.

FIG. 8A is a perspective view of a conventional air compressor including a “hot dog” shaped conventional compressed air storage tank, FIG. 8B is a schematic illustration of the general shape of the tank of FIG. 8A and FIG. 8C is a cross-sectional view of FIG. 8B as seen along line 8C-8C in which arrows are used to represent lines of force on an inner surface of the tank.

FIG. 9A is a perspective view of a conventional air compressor including a “pancake” shaped conventional compressed air storage tank, FIG. 9B is a schematic illustration of the general shape of the tank of FIG. 9A and FIG. 9C is a cross-sectional view of FIG. 9B as seen along line 9C-9C in which arrows are used to represent lines of force on an inner surface of the tank.

### DETAILED DESCRIPTION

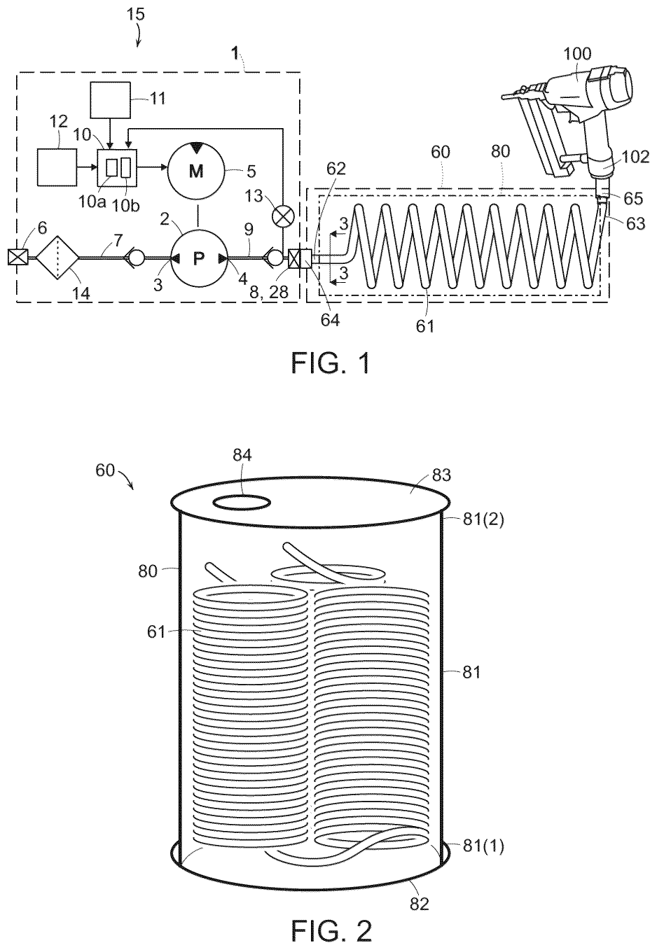

Referring to FIGS. 1 and 2, a power tool system 15 includes a compressed air-driven power tool 100, an air compressor 1, and a compressed air storage device 60. The power tool 100 may be a hand-held tool such as a nail gun, an impact wrench, an air ratchet, an air hammer, an air drill, an air sander, an air grinder, a spray gun, a staple gun, or any other air driven power tool. The power tool 100 is directly connected to the air compressor 1 via the compressed air storage device 60. In the illustrated embodiment, the compressed air storage device 60 includes an elongate, flexible air storage element 61 that is configured to store air that has been compressed to pressures of 50 to 300 pounds per square inch (PSI) or more and to provide a reservoir for a steady supply of pressurized air to the power tool 100 during tool operation. In addition, the compressed air storage device 60 includes a lightweight container element 80 that receives and stores the air storage element 61 therein. The air compressor 1 includes a compressor housing 20 including fluid couplings that permit fluid tight connection to the air storage device 60. The air storage element 61 is sufficiently flexible to permit bending including coiling, whereby the lengthy air storage element 61 can be compactly stored in the container element 80 and transported with the air compressor 1. The compressed air storage device 60 can be used when the air storage element 61 is in a fully coiled and stowed configuration. Alternatively, the compressed air storage device 60 may be used when the air storage element 61 is in a partially stowed configuration or when the air storage element 61 has been fully removed from the container element 80. The air compressor 1 and compressed air storage device 60 will now be described in detail.

The air compressor 1 may be a positive displacement compressor such as a provided by a reciprocating piston pump but is not limited to this type of pump. The air compressor 1 includes a compressor housing 20 described in detail below. The compressor housing 20 encloses and/or supports the other components of the air compressor 1, including a compressor pump 2, a motor 5, a controller 10, a human machine interface (HMI) 11, a battery 12, a pressure regulation device 13 and other ancillary components required for operation of the air compressor 1.

In the illustrated embodiment, the compressor pump 2 is a reciprocating piston pump, but may be another type of positive displacement pump. The compressor pump 2 uses one or more reciprocating pistons (not shown) to compress air. The compressor pump 2 includes an air inlet 3 and an air outlet 4.

The air inlet 3 is connected to a compressor air intake valve 6 via a first fluid line 7. The air intake valve 6 is supported on the compressor housing 20. When the air intake valve 6 is in an open position, air in the environment of the compressor 1 (e.g., air at atmospheric pressure) is permitted to enter first fluid line 7. When the air intake valve 6 is in a closed position, air in the environment of the compressor 1 is prevented from entering the first fluid line 7. An air filter 14 may be provided in the first fluid line 7 at a location between the air intake valve 6 and the pump air inlet 3.

The air outlet 4 is connected to a compressor air exhaust valve 8 via a second fluid line 9. The air exhaust valve 8 is supported on the compressor housing 20 and includes an integrated fluid coupling 28. When the air exhaust valve 8 is in an open position, air that has been compressed by the compressor pump 2 is permitted to exit the compressor housing 20. If the compressed air storage device 60 is coupled to the air exhaust valve fluid coupling, air that has been compressed by the compressor pump 2 is permitted to enter the compressed air storage device 60. When the air exhaust valve 8 is in a closed position, compressed air is prevented from exiting the compressor housing 20.

The pressure regulation device 13 is configured to monitor the output pressure of the air compressor 1. In the illustrated embodiment, the pressure regulation device 13 may be a pressure switch that monitors the pressure of the fluid exhausted from the compressor pump 2 and outputs a signal to the controller indicating the detected pressure. For example, the pressure switch may detect the pressure of the second fluid line 9 at a location between the compressor pump 2 and the compressor exhaust valve 8.

The motor 5 is an electric motor. In some embodiments, the motor 5 may be an induction motor, but is not limited to this type of motor. An output shaft (not shown) of the motor 5 is connected to the compressor pump 2 and motor 5 drives the pump 2 to compress air.

In the illustrated embodiment, a battery 12 is included in the compressor housing 20 and supplies power to the controller 10, which in turn supplies power to the motor 5. The battery 12 may be a rechargeable battery that is charged via a detachable wired connection to utility power. In some embodiments, the air compressor 1 may omit the battery 12 and obtain power via a direct wired connection to utility power. In still other embodiments, the air compressor 1 may include the battery 12 and be capable of being powered by either the battery 12 or direct connection to utility power.

The controller 10 is communicatively coupled with the HMI 11, the battery 12 and the pressure regulation device 13 and is configured to control the motor 5 based on these inputs. As used herein, the term “communicatively coupled” may refer to a direct wired connection via for example electrically conductive signal lines, shared communication busses, or alternatively may refer to a wireless connection. Thus, controller 10 can receive information from these devices and selectively activate and operate the various operational components.

In some embodiments, controller 10 includes one or more memory devices 10a and one or more processors 10b. The processors 10b may be any combination of general or special purpose processors, CPUs, or the like that can execute programming instructions or control code associated with operation of the air compressor 1. The memory devices (i.e., memory) 10a may represent random access memory such as DRAM or read only memory such as ROM or FLASH. In some embodiments, the processor 10b executes programming instructions stored in memory 10a. The memory 10a may be a separate component from the processor 10b or may be included onboard within the processor 10b. Alternatively, the controller 10 may be constructed without using a processor 10b, for example, using a combination of discrete analog or digital logic circuitry (such as switches, amplifiers, integrators, comparators, flipflops, AND gates, and the like) to perform control functionality instead of relying upon software.

In some embodiments, the controller 10 includes a network interface such that the controller 10 can connect to and communicate over one or more networks (not shown). The controller 10 may also include one or more transmitting, receiving, or transceiving components for transmitting and/or receiving communications with other devices communicatively coupled with the air compressor 1. Additionally, or alternatively, the transmitting, receiving, or transceiving components can be located off board controller 10. Generally, the controller 10 may be positioned in any suitable location throughout the compressor housing 20.

The various functions performed by the controller 10 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The compressor housing 20 includes an interior vacancy that receives and supports the compressor pump 2, the motor 5, the air filter 14, the pressure regulation device 13, the HMI 11, the controller 10, the air intake and exhaust valves 6, 8 and any ancillary components needed for compressor operation.

The HMI 11 is mounted on an outer surface of the compressor housing 20 and may include switches or other input devices and/or a display. The HMI 11 is configured to permit the user to operate the air compressor 1 and receive information about air compressor performance. In some embodiments, the display may be colored, non-colored (e.g., gray-scale), or a combination of both. The display may be implemented as any type of display including a liquid crystal display (LCD), light emitting diodes (LED), organic light emitting diodes (OLED) or any other alternative configuration known to one of ordinary skill in the art. The display may provide touch-screen functionality and an air pressure level selector may be integrated into the HMI 11.

In the illustrated embodiment, the air exhaust valve 8 terminates in a hose coupling 28 that protrudes from the compressor housing 20 at a location adjacent to the HMI but is not limited to this location. The hose coupling 28 is configured to provide a fluid tight mechanical connection to a first coupling 64 of the air storage device 60. In addition, in some embodiments, the hose coupling 28 may include 360 degree, bidirectional swivel functionality such that the air storage device 60 is capable of rotation relative to the compressor housing 20.

Referring also to FIG. 3, the compressed air storage device 60 includes the elongate, flexible air storage element (or “tube”) 61 and the container element 80. The air storage element 61 may be used and/or stored in the container element 80, and also may be used while partially contained within the container element 80 or fully extracted from the container element 80. The air storage element 61 is configured to store compressed air and to provide a reservoir for a steady supply of pressurized air to the power tool 100 during tool operation.

The air storage element 61 includes an elongated tube having an element first end 62 that is detachably coupled to the hose coupling 28 of the air exhaust valve 8 via an element first coupling 64. The air storage element 61 includes an element second end 63 that is opposite the element first end 62. The element second end 63 includes a device second coupling 65.

The element first coupling 64 is configured to be detachably connected to the hose coupling 28 of the air compressor 1 in a fluid-tight manner, for example using a quick connect fitting suitable for high pressure applications. Similarly, the element second coupling 65 is configured to be detachably connected to the tool coupling 102 in a fluid tight manner, for example using a quick connect fitting suitable for high pressure applications. Alternatively, other fitting types such as threaded or barbed fitting could be employed when appropriate.

The air storage element 61 is elongated. In particular, the tube of the air storage element has a diameter d that is much smaller than a length (not shown) of the tube, where the length of the air storage element 61 corresponds to a distance between the element first and second ends 62, 63. The air storage element length is at least 10 times the diameter d of the air storage element 61. In some embodiments, the air storage element length is more than 50 times the diameter d of the air storage element 61.

The size and capacity of the air storage element 61 may depend on factors such as the output capacity of the air compressor 1, the required air pressure, and the specific application's air demand (for example, the pressure required by the power tool 100). In some embodiments, the air storage device 60 has sufficient capacity to handle the required tool operating (including firing) pressure and to provide sufficient storage capacity to meet the needs of the compressed air system. More specifically, the air storage element 61 has an interior volume that is sufficient to power a pneumatic power tool, which may require a storage capacity of eight liters or more to maintain a high airflow applications. However, most pneumatic tools are operable at lower capacities. Nail guns, for example, are operable using a one liter capacity. Increasing air storage element interior space volume by providing an air storage element 61 of increased length is one way to accomplish increased storage capacity.

The tubular air storage element 61 is constructed using multiple layers of materials to ensure durability, flexibility, and resistance to high-pressure air. In the illustrated embodiment, the air storage element 61 includes an inner tube 66, at least one reinforcement layer 68 and an outer tube 69. The innermost layer of the air storage element 61 is the inner tube 66, which is responsible for carrying the compressed air. The inner tube 66 may be made of synthetic rubber or a similar material that can withstand high-pressure air and resist degradation from oil or moisture. The reinforcement layer(s) 68 surround the inner tube 66 and provides strength and stability to the air storage element 61. In the illustrated embodiment, there are four reinforcement layers 68. Each reinforcement layer may be made of braided or spiraled metal fibers or synthetic fibers, such as polyester or nylon. The reinforcement layers 68 help the air storage element 61 withstand the internal pressure cause by compressed air and prevent the air storage element 61 from expanding or bursting. The outermost layer of the air storage element 61 is the outer tube 69 or cover, which protects the inner layers 66, 68 from external damage, abrasion, and exposure to the elements. The outer tube 69 may be made of synthetic rubber or a blend of rubber and other materials. The outer tube 69 is designed to be resistant to oil, chemicals, UV rays, and general wear and tear. The construction of the air storage element 61 may vary depending on the specific application and the desired flexibility.

The compressed air storage device first and second couplings 64, 65 are connectors or fittings that allow for easy attachment to the compressor and other pneumatic tools or equipment. The device first and second couplings 64, 65 fittings may be made of brass, steel, or other durable materials and are typically threaded or equipped with quick-connect mechanisms for secure and leak-free connections.

In addition, the compressed air storage device 60 includes a lightweight container element 80 that receives and stores the air storage element 61 therein. The container element 80 is shaped and dimensioned to accommodate the air storage element 61 when in a folded, wound, coiled, randomly piled or other storage configuration. In the embodiment illustrated in FIG. 2, the container element 80 is a hollow cylindrical structure that includes a container sidewall 81, a container first end 82 and a container second end 83. The container first end 82 is a circular plate that is fixed to a sidewall first end 81(1) and closes the sidewall first end 81(1). The container first end 82 serves as a support base. The container second end 83 is a circular plate that is disposed at a sidewall second end 81(2) which is opposite the sidewall first end 81(1). The container second end 83 serves as a lid. In some embodiments, the container second end 83 is detachably connected to the sidewall second end 81(2), for example via a press fit, while in other embodiments the container second end 83 is connected to the sidewall second end 81(2) via hinges and latches or other known connection methods.

Because the container element 80 serves as a storage device, the internal surfaces of the container element are subjected to atmospheric pressures. For this reason, the container element 80 may be formed of thin, lightweight materials such as sheet or injection molded plastic (shown), plastic mesh, woven fabric formed of natural or synthetic fibers, plastic or wire fencing, nylon webbing or other appropriate material. Although the container first end 82 may rest directly on a support surface such as a floor or table, the container first end 82 may be supported above the ground by feet (not shown), wheels (not shown) or castors (not shown).

In some embodiments, the container element 80 may include an opening 84 through which a portion of the air storage element 61 may extend to permit connection to an external device such as the compressor 1. The location of the opening 84 may depend on the requirements of the application. In the illustrated embodiment, the opening 84 is located near a periphery of the container second end 83. Although only one opening 84 is shown, the container element may include a plurality of openings 84 for convenient access to the air storage element 61 and/or for weight reduction of the container element 80.

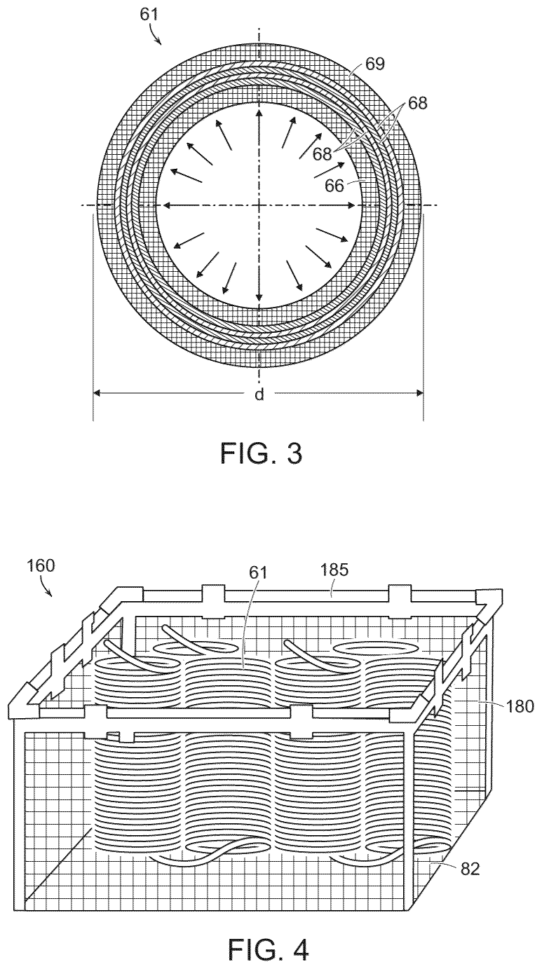

Referring to FIG. 4, an alternative embodiment air storage device 160 is similar to the air storage device 60 of FIGS. 1-3, and common reference numbers are used to refer to common elements. The air storage device 160 shown in FIG. 4 differs from the previous embodiments in that the air storage device 160 includes an alternative embodiment container element 180 that is shaped and dimensioned to accommodate the air storage element 61 when in a folded, wound, coiled, randomly piled or other storage configuration. In FIG. 4, the container element 180 includes a three-dimensional support frame 182 that is covered in a coarse mesh fabric that provide perforated sidewalls 81 of the container element 180. The mesh fabric may be natural fiber, plastic or metal. The support frame 182 is not limited to being covered by a mesh. Other appropriate materials may be used, including, but not limited to sheet or injection molded plastic, tightly woven fabric formed of natural or synthetic fibers, plastic or wire fencing, nylon webbing, etcetera. In the illustrated embodiment, the support frame 182 defines a rectangular enclosure. However, the support frame 182 is not limited to this configuration and may be formed in other shapes.

Although a lid or cover is not shown, the container element 180 may include a lid or cover if required by the specific application. Although the container first end 82 may rest directly on a support surface such as a floor or table, the container first end 82 may be supported above the ground by feet (not shown), wheels (not shown) or castors (not shown).

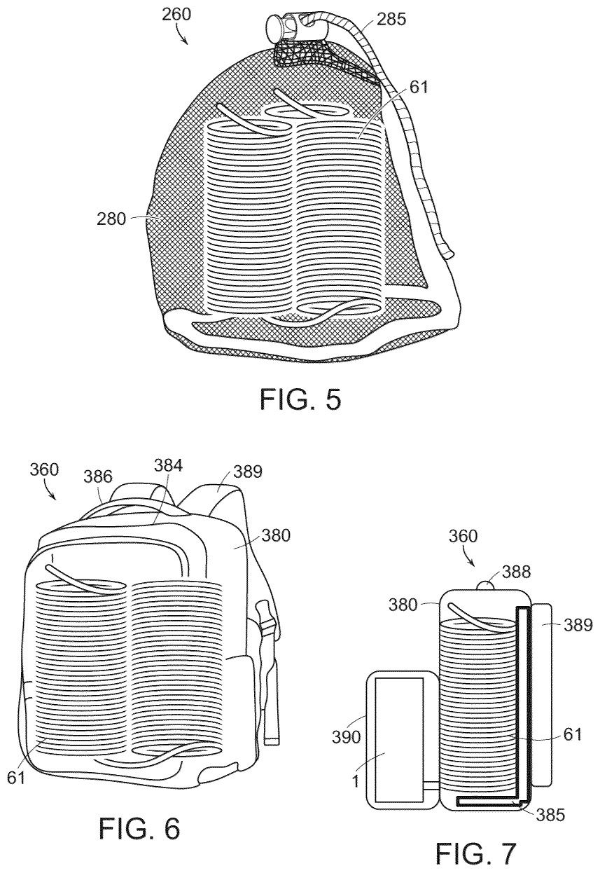

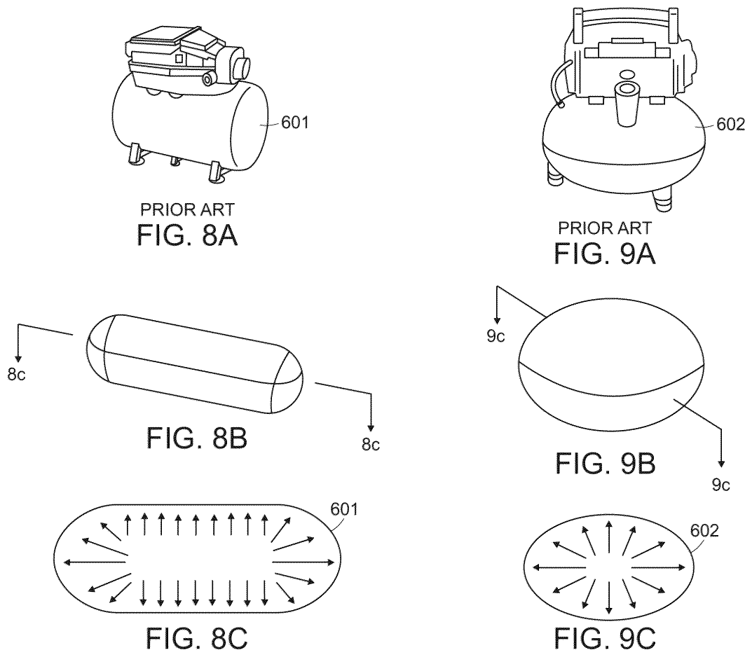

Referring to FIG. 5, an alternative embodiment air storage device 260 is similar to the air storage device 60 of FIGS. 1-3, and common reference numbers are used to refer to common elements. The air storage device 260 shown in FIG. 5 differs from the previous embodiments in that the air storage device 260 includes another alternative embodiment container element 280 that is shaped and dimensioned to accommodate the air storage element 61 when in a folded, wound, coiled, randomly piled or other storage configuration. In FIG. 5, the container element 280 is a mesh bag that is free of a support frame. In the illustrated embodiment, the container second end 82 is closed by a draw string 285. The container element 280 may be carried by the draw string 285. Alternatively, the container element 280 may include soft handles or other suitable structures that facilitate lifting and carrying of the container element 280.

Referring to FIGS. 6 and 7, another alternative embodiment air storage device 360 is similar to the air storage device 260 of FIG. 5, and common reference numbers are used to refer to common elements. The air storage device 360 shown in FIGS. 6 and 7 differs from the previous embodiments in that air storage device 360 includes yet another alternative embodiment container element 380 that is shaped and dimensioned to accommodate the air storage element 61 when in a folded, wound, coiled, randomly piled or other storage configuration. The container element 380 is a cloth or plastic bag having the configuration of a backpack. The container element 380 may optionally include a minimal internal support structure 385 as are sometimes provided in conventional backpacks. The container second end 82 may be selectively opened and closed via a zipper 384. The container second end 82 may also include a handle 388 and the container sidewall 81 may be provided with adjustable shoulder straps. The backpack-style container element 380 may include a large external storage pocket 390 that is shaped and dimensioned to support an air compressor 1, and the compressed air system 15 may be worn by the user during operation of the system.

In the power tool system 15, the power tool 100 is directly connected to the air compressor 1 via the compressed air storage device 60, 160, 260, 360. That is to say, the element first coupling 64 is directly connected to the coupling of the air exhaust valve 8 of the air compressor 1 with no intervening structures or devices. In addition, the element second coupling 65 is directly connected to the tool coupling 102 of the power tool 100 with no intervening structures or devices. Moreover, the air storage element 61 stores compressed air for driving the power tool 100 during use.

Although the air storage device 60 is shown in FIGS. 1 and 2 with the element first coupling 64 connected to the hose coupling 28 of the air compressor 1 and with the element second coupling 65 connected to the tool coupling 102, the air storage device 60 is not limited to this configuration. For example, the air storage device 60 may be used in the opposite orientation.

Selective illustrative embodiments of the compressed air supply system including the air compressor and the air storage device are described above in some detail. It should be understood that only structures considered necessary for clarifying the compressed air supply system have been described herein. Other conventional structures, and those of ancillary and auxiliary components of the compressed air supply system are assumed to be known and understood by those skilled in the art. Moreover, while a working example of the compressed air supply system has been described above, the system is not limited to the working example described above, but various design alterations may be carried out without departing from the system and/or the components thereof as set forth in the claims.

1. A compressed air storage device configured to be connected to an air output of an air compressor, the compressed air storage device comprising an air storage element and a container element, wherein
the air storage element includes a tubular body having a first end and a tube second end opposite the tube first end, the tubular body having a diameter and a length, where the length is equal to the distance between the tube first end and the tube second end when the tubular body is arranged parallel to a line, the length being at least fifty times the diameter,
the tubular body including a reinforced tube wall,
the container element comprising a container housing that is shaped and sized to receive the air storage element therein.

2. The compressed air storage device of claim 1, wherein the container element comprises a sidewall than encircles the air storage element and a closed end at one end of the sidewall, and at least one of the sidewall and the closed end includes perforations.

3. The compressed air storage device of claim 2, wherein at least one of the sidewall and the closed end is formed of a woven material.

4. The compressed air storage device of claim 1, wherein the container element comprises a sidewall than encircles the air storage element and a closed end at one end of the sidewall, and at least one of the sidewall and the closed end is formed of plastic.

5. The compressed air storage device of claim 1, wherein the container element comprises a sidewall than encircles the air storage element and a closed end at one end of the sidewall, and at least one of the sidewall and the closed end is formed of a pliable material.

6. The compressed air storage device of claim 1, wherein the container element comprises a structural support frame and a woven fabric covering that encloses the support frame.

7. The compressed air storage device of claim 1, wherein the container housing is configured to be selectively opened and closed to permit access to an interior space of the container element.

8. The compressed air storage device of claim 1, wherein the container housing comprises a lid that is configured to permit access to an interior space of the container element.

9. An air compressor system comprising:
an air compressor having an air output, and
a compressed air storage device, the compressed air storage device comprising an air storage element and a container element, wherein
the air storage element includes a tubular body having a tube first end operably connected to the air output and configured to store compressed air, and a tube second end opposite the tube first end, the tubular body having a diameter and a length, where the length is equal to the distance between the tube first end and the tube second end when the tubular body is arranged parallel to a line, the length being at least fifty times the diameter,
the tubular body including a reinforced tube wall,
the container element comprising a container housing that is shaped and sized to receive the air storage element therein.

10. The air compressor system of claim 9, comprising an air driven tool including a tool coupling, wherein the tube second end is operably connected to the tool coupling.

11. The air compressor system of claim 9, wherein the container element comprises a sidewall than encircles the air storage element and a closed end at one end of the sidewall, and at least one of the sidewall and the closed end includes perforations.

12. The air compressor system of claim 11, wherein at least one of the sidewall and the closed end is formed of a woven material.

13. The air compressor system of claim 9, wherein the container element comprises a sidewall than encircles the air storage element and a closed end at one end of the sidewall, and at least one of the sidewall and the closed end is formed of plastic.

14. The air compressor system of claim 9, wherein the container element comprises a sidewall than encircles the air storage element and a closed end at one end of the sidewall, and at least one of the sidewall and the closed end is formed of a pliable material.

15. The air compressor system of claim 9, wherein the container element comprises a structural support frame and a woven fabric covering that encloses the support frame.

16. The air compressor system of claim 9, wherein the container housing is configured to be selectively opened and closed to permit access to an interior space of the container element.

17. The air compressor system of claim 9, wherein the container housing comprises a lid that is configured to permit access to an interior space of the container element.
